(19) United States
(12) Patent Application Publication
(10) Pub. No.: US 2026/0203315 A1
(43) Pub. Date: Jul. 16, 2026

(54) INFORMATION PROCESSING APPARATUS, DETECTION METHOD, AND COMPUTER-READABLE MEDIUM

(71) Applicant: NEC Corporation, Tokyo (JP)

(72) Inventors: Masaharu MORIMOTO, Tokyo (JP); Masaki INOKUCHI, Tokyo (JP); Yoshiaki SAKAE, Tokyo (JP); Joe BRINTON, Tokyo (JP); Sianen OOI, Tokyo (JP); Ryosuke HOTCHI, Tokyo (JP); Shunsuke OSAKI, Tokyo (JP); Tatsuya FUKUDA, Tokyo (JP)

(73) Assignee: NEC Corporation, Tokyo (JP)

(21) Appl. No.: 19/439,777

(22) Filed: Jan. 5, 2026

(30) Foreign Application Priority Data
Jan. 15, 2025 (JP) 2025-005707

(51) Int. Cl. G06F 16/3329

(52) U.S. Cl. CPC G06F 16/3329

(57) ABSTRACT

An information processing apparatus according to an aspect includes one or more memories for storing instructions and one or more processors for executing the instructions. The one or more processors execute the instructions to receive an operation of designating a first description that is a part of a description of a second document generated by using the first document, and detect a related description related to a second description that is different in expression from the first description and is related in content to the first description from among descriptions included in the first document.

### INCORPORATION BY REFERENCE

This application is based upon and claims the benefit of priority from Japanese patent application No. 2025-005707, filed on January 15, 2025, the disclosure of which is incorporated herein in its entirety by reference.

### TECHNICAL FIELD

The present disclosure relates to an information processing apparatus, a detection method, and a detection program.

### BACKGROUND ART

A technique of automatically generating a new document from an original document is known. For example, JP 2023-184314 A discloses that a summary sentence is generated from an original sentence by an artificial intelligence (AI) model.

However, the content of the document generated by the AI model is not necessarily appropriate. Therefore, in a case where a new document is generated from an original document, it is necessary for a person to perform work of confirming which description of the original document is associated with each description of the new document. Such work is not limited to the document generated by the AI model, and is also performed on a document created by a person.

### SUMMARY

In the confirmation work described above, it is convenient that which description of the original document is associated with each description of the generated new document (that may be a document automatically generated or a document created by a person) can be easily confirmed. Here, in a case where a summary sentence is designated, a summary processing apparatus disclosed in JP 2023-184314 A can display a frequent occurrence location of a word included in the summary sentence in the original sentence as a correspondence location. Thus, it is conceivable that, as long as this summary processing apparatus is used, a user can be caused to easily recognize a correspondence relationship between the original sentence and the summary sentence, and the above-described confirmation work can be facilitated.

However, in a case where a word included in the summary sentence is not included in the original sentence in addition to a case where a word included in the summary sentence is not necessarily included in the original sentence, it is not possible for the summary processing apparatus disclosed in JP 2023-184314 A to display the correspondence location. As described above, the summary processing apparatus disclosed in JP 2023-184314 A has room for improvement in that it is not possible to detect a correspondence location in a case where related matters are described in different expressions in the original sentence and the summary sentence. Such a problem is a problem that occurs in common in a case of detecting a related description in any first document and any second document generated automatically or manually by using the first document.

An example object of the present disclosure is to provide a technique capable of detecting a related description in a first document and a second document generated by using the first document even in a case where related matters are described in different expressions.

According to an example aspect of the present disclosure, an information processing apparatus includes one or more memories for storing instructions, and one or more processors that execute the instructions. The one or more processors execute the instructions to receive an operation of designating a first description that is a part of a description of a first document or a second document generated by using the first document, on any of the first document and the second document, and detect a related description that is related to a second description that is different in expression from the first description and is related in content to the first description from among descriptions included in a non-designated document that is not a target of designation of the first description among the first document and the second document.

According to another example aspect of the present disclosure, there is provided a detection method for causing at least one processor to execute a reception process of receiving an operation of designating a first description that is a part of a description of a first document or a second document generated by using the first document, on any of the first document and the second document, and a detection process of detecting a related description that is related to a second description that is different in expression from the first description and is related in content to the first description from among descriptions included in a non-designated document that is not a target of designation of the first description among the first document and the second document.

According to still another example aspect of the present disclosure, a detection program causes a computer to function as reception means for receiving an operation of designating a first description that is a part of a description of a first document or a second document generated by using the first document, on any of the first document and the second document, and detection means for detecting a related description that is related to a second description that is different in expression from the first description and is related in content to the first description from among descriptions included in a non-designated document that is not a target of designation of the first description among the first document and the second document.

According to an example aspect of the present disclosure, it is possible to exhibit an exemplary effect that it is possible to detect a related description in a first document and a second document generated by using the first document even in a case where related matters are described in different expressions.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of a detection method according to the present disclosure;

FIG. 3 is a block diagram illustrating a configuration of another information processing apparatus according to the present disclosure;

FIG. 4 is a diagram illustrating an example in which a second document is generated from a first document;

FIG. 5 is a diagram for describing an example of a conversion method of a description;

FIG. 6 is a diagram illustrating an example of correspondence information;

FIG. 7 is a diagram illustrating an example of a display screen displayed by a display control unit;

FIG. 8 is a flowchart illustrating a flow of processing executed by the information processing apparatus illustrated in FIG. 3; and

FIG. 9 is a block diagram illustrating a configuration of a computer that functions as the information processing apparatus according to the present disclosure.

### EXAMPLE EMBODIMENTS

Hereinafter, example embodiments of the present disclosure will be described. However, the present disclosure is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present disclosure. Example embodiments obtained by appropriately omitting some of the techniques adopted in the following exemplary example embodiments can also be included in the scope of the present disclosure. Effects mentioned in the following exemplary example embodiments are examples of effects expected in the exemplary example embodiments, and do not define extension of the present disclosure. In other words, example embodiments that do not provide the effects mentioned in the following exemplary example embodiments can also be included in the scope of the present disclosure.

Further, each embodiment can be appropriately combined with at least one of embodiments. Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

### First Exemplary Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technology illustrated in the drawings referred to for describing the present exemplary example embodiment may also be adopted in another exemplary example embodiment included in the present disclosure within a range in which no particular technical problem occurs.

### Configuration of Information Processing Apparatus 1

A configuration of an information processing apparatus 1 will be described with reference to FIG. 1. FIG. 1 is a block diagram illustrating the configuration of the information processing apparatus 1. As illustrated in FIG. 1, the information processing apparatus 1 includes a reception unit 101 and a detection unit 102.

The reception unit 101 receives an operation of designating a first description that is a part of a description of a first document or a second document generated by using the first document, on any of the first document and the second document.

The first document only needs to include information necessary for generating the second document, and any document relevant to the second document to be generated can be set as the first document. For example, in a case where the second document is a detailed design document indicating a specific configuration for achieving, as a design target, the first document may be a basic design document or the like indicating the function in an abstract or conceptual manner. For example, in a case where a document obtained by summarizing the first document is set as the second document, the first document may be any document that can be summarized. In addition, for example, the first document may be set as an electronic medical record, and the second document may be set as a medical document such as a medical certificate. As described above, the information processing apparatus 1 can also be used in the healthcare field. The first document and the second document only need to include text in a natural language at least in part. For example, the first document and the second document may include data in a format other than text (for example, an image) in addition to text.

The second document may be automatically generated by the information processing apparatus 1 or another computer, or may be created by a person. A part of the second document may be automatically generated by a computer, and another part may be created by a person. That is, the second document only needs to be generated by using the first document, and any generation method and any generation subject are applicable. The second document may be generated by using a plurality of documents, and in this case, a data set including the plurality of documents is set as the first document. The second document may be a data set including a plurality of documents.

The detection unit 102 detects a related description related to a second description that is different in expression from a first description and is related in content to the first description from among descriptions included in a document (hereinafter, referred to as a non-designated document) that is not a target of designation of the first description among the first document and the second document.

The second description only needs to be different in expression from the first description and be related in content to the first description. For example, it can be said that descriptions representing common subjects in different expressions include related contents. For example, the second description may be a description obtained by abstracting the first description or a description obtained by concretizing the first description. “Abstraction” can also be rephrased as a superordinate concept, generalization, or the like. “Concretization” can also be referred to as subconceptualization, non-abstraction, or the like. The second description may be a description that is not included in either the first document or the second document.

The related description only needs to be a description possessing some relevance with the second description. What kind of description relevant to the content is detected as the related description may change depending on a detection method applied by the detection unit 102. For example, the detection unit 102 may detect, as the related description, a description possessing the largest similarity in content, that is, the degree of similarity in content to the second description, among descriptions included in the non-designated document. In this case, a description relevant to the second description in that the content is similar is detected as the related description.

As described above, the information processing apparatus 1 according to the present exemplary example embodiment employs a configuration including the reception unit 101 that receives an operation of designating a first description that is a part of a description of a first document or a second document generated by using the first document, on any of the first document and the second document, and the detection unit 102 that detects a related description that is related to a second description that is different in expression from the first description and is related in content to the first description from among descriptions included in a non-designated document that is not a target of designation of the first description among the first document and the second document.

According to the above configuration, not the designated first description but the related description related to the second description that is different in expression from the first description and is related in content to the first description is detected from the descriptions included in the non-designated document. As a result, at time of reflecting the first description in the second document during generation of the second document, even in a case where an expression such as abstraction or concretization of the first description is changed, it is possible to detect the description of the non-designated document that is related in content to the first description, as the related description. Thus, according to the information processing apparatus 1, it is possible to obtain an effect that, even in a case where related items are described in different expressions in the first document and the second document, it is possible to detect related descriptions in these documents. According to the information processing apparatus 1, it is also possible to optimize the confirmation work of the second document.

### Detection Program

The functions of the information processing apparatus 1 described above can also be achieved by a program. According to the present exemplary example embodiment, a detection program causes a computer to function as reception means for receiving an operation of designating a first description that is a part of a description of a first document or a second document generated by using the first document, on any of the first document and the second document, and detection means for detecting a related description that is related to a second description that is different in expression from the first description and is related in content to the first description from among descriptions included in a non-designated document that is not a target of designation of the first description among the first document and the second document. According to the detection program, it is possible to obtain an effect that, even in a case where related items are described in different expressions in the first document and the second document, it is possible to detect related descriptions in these documents.

### Flow of Detection Method

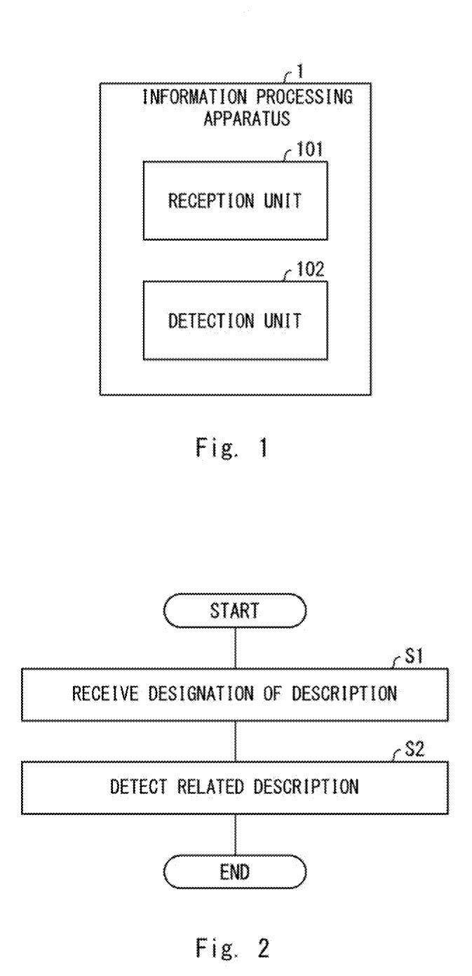

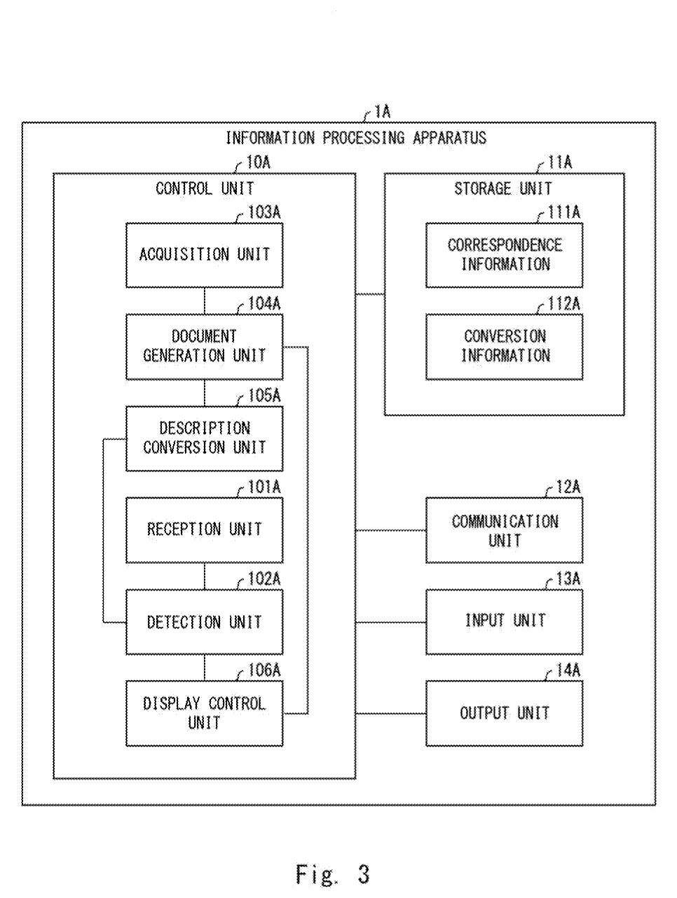

An example of a flow of the detection method will be described with reference to FIG. 2. FIG. 2 is a flowchart illustrating the flow of the detection method. An execution subject of each step in this detection method may be a processor included in the information processing apparatus 1 or may be a processor included in another apparatus, or execution subjects of the respective steps may be processors provided in different apparatuses.

In S1 (reception process), at least one processor receives an operation of designating a first description that is a part of a description of a first document or a second document generated by using the first document, on any of the first document and the second document.

In S2 (detection process), at least one processor detects a related description related to a second description that is different in expression from a first description and is related in content to the first description from among descriptions included in a non-designated document that is not a target of designation of the first description among the first document and the second document.

As described above, the detection method according to the present exemplary example embodiment employs a configuration in which at least one processor executes the reception process of receiving an operation of designating a first description that is a part of a description of a first document or a second document generated by using the first document, on any of the first document and the second document, and the detection process of detecting a related description that is related to a second description that is different in expression from the first description and is related in content to the first description from among descriptions included in a non-designated document that is not a target of designation of the first description among the first document and the second document. According to the detection method, it is possible to obtain an effect in that, even in a case where related items are described in different expressions in the first document and the second document, it is possible to detect related descriptions in these documents.

### Second Exemplary Example Embodiment

A second exemplary example embodiment that is an example of the example embodiments of the present disclosure will be described in detail with reference to the drawings. Components possessing the same functions as the components described in the above-described exemplary example embodiment are denoted by the same reference signs, and the description thereof will be appropriately omitted. An application range of each of techniques adopted in the present exemplary example embodiment is not limited to the present exemplary example embodiment. That is, each technique adopted in the present exemplary example embodiment can also be adopted in another example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### Configuration of Information Processing Apparatus 1A

A configuration of an information processing apparatus 1A will be described with reference to FIG. 3. FIG. 3 is a block diagram illustrating the configuration of the information processing apparatus 1A. The information processing apparatus 1A is an apparatus including a function of supporting confirmation work of a content of a document. The information processing apparatus 1A may be a local device used by individual users, or may be a server that provides a document confirmation support service to a plurality of users.

As illustrated, the information processing apparatus 1A includes a control unit 10A that integrally controls each unit of the information processing apparatus 1A, and a storage unit 11A that stores various types of data to be used by the information processing apparatus 1A. The information processing apparatus 1A includes a communication unit 12A for the information processing apparatus 1A to communicate with another device, an input unit 13A that receives an input to the information processing apparatus 1A, and an output unit 14A for the information processing apparatus 1A to output data. The control unit 10A includes a reception unit 101A, a detection unit 102A, an acquisition unit 103A, a document generation unit 104A, a description conversion unit 105A, and a display control unit 106A. The storage unit 11A stores correspondence information 111A and conversion information 112A.

The reception unit 101A receives various operations regarding document confirmation support. For example, similarly to the reception unit 101 in the first exemplary example embodiment, the reception unit 101A receives an operation of designating a first description that is a part of a description of a first document or a second document generated by using the first document, on any of the first document and the second document. Any method of receiving the operation is applicable. For example, the reception unit 101A may receive an operation via the input unit 13A, or may receive an operation from another apparatus via the communication unit 12A.

Similarly to the detection unit 102 in the first exemplary example embodiment, the detection unit 102A detects a related description related to a second description that is different in expression from a first description and is related in content to the first description from among descriptions included in a non-designated document that is not a target of designation of the first description among the first document and the second document. A detection method for the related description by the detection unit 102A will be described later.

The detection unit 102A generates the correspondence information 111A by using the detected related description. Although details will be described later, the correspondence information 111A is information for detecting a related description in which a description extracted from the first document and a description extracted from the second document are associated with each other. Therefore, after generating the correspondence information 111A, the detection unit 102A can detect the related description by using the generated correspondence information 111A.

The acquisition unit 103A acquires various types of data regarding document confirmation support. For example, the acquisition unit 103A acquires a first document that is original data as a source of a second document. Any method of acquiring various pieces of data including the first document is applicable. For example, the acquisition unit 103A may acquire data from an external device (for example, a terminal device or the like used by the user) via the communication unit 12A, or may acquire data input to the information processing apparatus 1A via the input unit 13A.

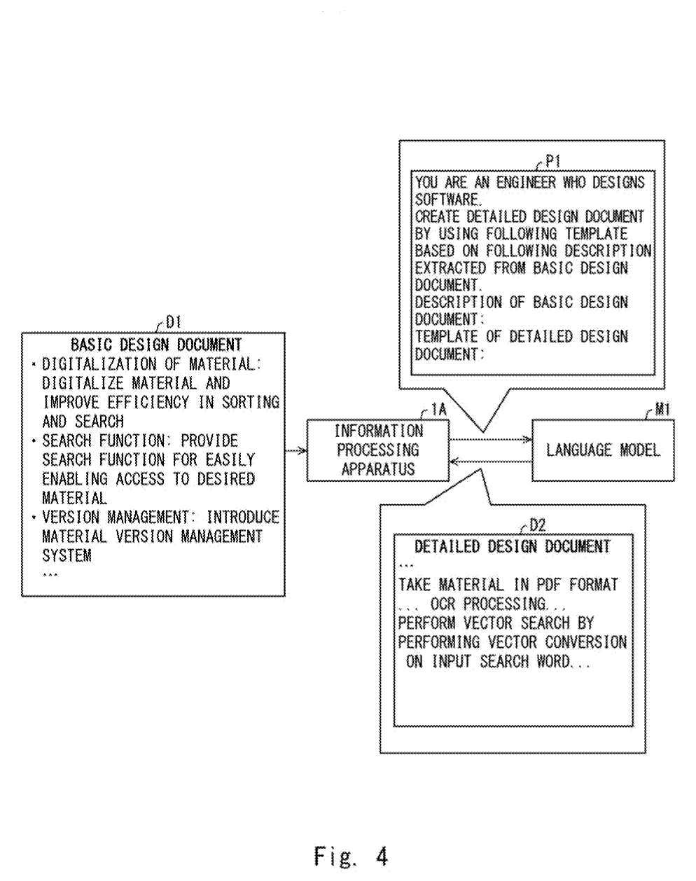

The document generation unit 104A generates the second document by using the first document acquired by the acquisition unit 103A. A method of generating the second document will be described later with reference to FIG. 4. The second document may be manually generated, or may be generated by another apparatus. In these cases, it is sufficient that the document generation unit 104A is omitted, and the acquisition unit 103A acquires the second document generated outside the information processing apparatus 1A.

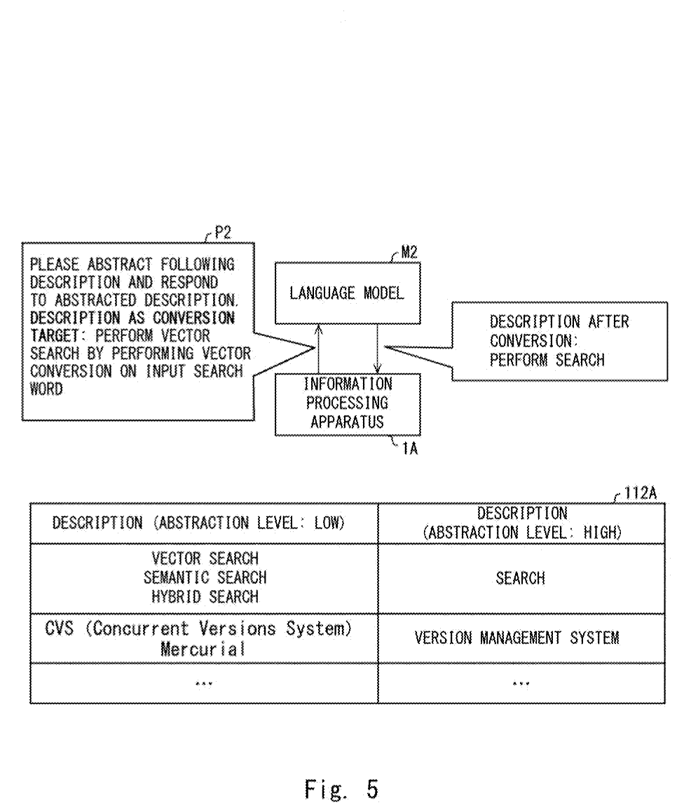

The description conversion unit 105A converts a description as a conversion target into a description that is different in expression from this description and is related in content to this description. The description as the conversion target is a description of the first document or the second document. Although details will be described later with reference to FIG. 5, the description conversion unit 105A can perform the above conversion by using the conversion information 112A or the language model.

The display control unit 106A presents various types of information regarding document confirmation support. For example, the display control unit 106A displays the first document and the second document. For example, the display control unit 106A displays the related description detected by the detection unit 102A among displayed descriptions of the first document and the second document in such a way as to be distinguishable from other descriptions.

In a case where the output unit 14A has a function of displaying and outputting an image, the display control unit 106A may cause the output unit 14A to display data as described above. The display control unit 106A may display the data described above on a display device (for example, a display device included in a terminal device used by the user) outside the information processing apparatus 1A via the communication unit 12A.

As described above, the information processing apparatus 1A includes the reception unit 101A that receives an operation of designating a first description that is a part of a description of a first document or a second document generated by using the first document, on any of the first document and the second document, and the detection unit 102A that detects a related description that is related to a second description that is different in expression from the first description and is related in content to the first description from among descriptions included in a non-designated document that is not a target of designation of the first description among the first document and the second document. Thus, according to the information processing apparatus 1A, similarly to the information processing apparatus 1, it is possible to obtain an effect that even in a case where related items are described in different expressions in the first document and the second document, it is possible to detect related descriptions in these documents.

### Example of Document Generation

As described above, the document generation unit 104A generates the second document by using the first document acquired by the acquisition unit 103A. Any method of generating the second document is applicable. For example, the document generation unit 104A may generate the second document by extracting each item to be written into the second document from the first document and inputting each extracted item to a template of the second document. A language model obtained by performing machine learning on a natural language can also be used to generate the second document.

Here, machine learning on natural language more specifically means learning of the arrangement of components (words and the like) in a sentence in a natural language and the arrangement of sentences in a text. Examples of the language model trained on natural language include bidirectional encoder representations from transformers (BERT), robustly optimized BERT approach (RoBERTa), efficiently learning an encoder that classifies token replacements accurately (ELECTRA), and the like.

In a case where the second document is generated by using the language model, the document generation unit 104A only needs to generate a prompt for instructing to generate the second document with reference to the first document, and input the generated prompt to the language model. As a result, the second document is output from the language model.

The document generation unit 104A may generate the second document by retrieval-augmented generation (RAG). Generation of the second document by RAG will be described with reference to FIG. 4. FIG. 4 is a diagram illustrating an example in which a second document is generated from a first document. In the example of FIG. 4, the information processing apparatus 1A (more specifically, the document generation unit 104A) generates a second document D2 from a first document D1 by using a language model M1 in which a natural language has been machine-learned. The first document D1 is specifically a basic design document of software, and the second document D2 is a detailed design document of software. As described above, the document generation unit 104A can also generate a design document for the downstream step from a design document for the upstream step in a design step.

In a case where the second document D2 is generated by RAG, the document generation unit 104A searches the first document D1 for information necessary for generating the second document D2. For example, the document generation unit 104A first generates a feature vector (also referred to as an embedding vector) indicating a feature of information necessary for generating the second document D2, based on a template of the second document D2 or the like. For example, a model such as Bi-Encoder can be used to generate the feature vector. Then, the document generation unit 104A calculates a similarity between the generated feature vector and a feature vector of each description included in the first document D1. Regarding various descriptions that are used for generating the second document D2 and include the first document D1, a feature vector may be calculated in advance, and the calculated feature vector may be recorded in a database or the like in association with an original description. Then, the document generation unit 104A acquires a description associated with the feature vector possessing the maximum calculated similarity, as the description to be used for generating the second document D2.

Then, the document generation unit 104A generates a prompt that includes the detected description and instructs to generate the second document D2 by using this description. In the example of FIG. 4, a prompt P1 is used. The prompt P1 includes a sentence that instructs to create a detailed design document based on a description of the basic design document and also includes the description of the basic design document. The description of the basic design document can be acquired from the first document D1 by searching using the feature vector as described above.

The prompt P1 includes a template of a detailed design document. As described above, by using the prompt including the template of the second document to be output, the second document in a predetermined format can be generated. Further, the prompt P1 includes a sentence that “you are an engineer who designs software”. It is not essential to include such a sentence, but the inclusion of such a sentence makes it possible to increase the probability of generating a second document with appropriate contents. The prompt P1 is fixed except for the content of the description of the basic design specification. Therefore, as long as the fixed part of the prompt P1 is stored in the storage unit 11A or the like as a template, the document generation unit 104A can generate the prompt P1 by using the template. An expression in the prompt P1 can be appropriately changed within a range in which a desired output can be obtained. For example, the document generation unit 104A may generate a prompt with different expressions depending on the types of the first document and the second document, the language model M1 to be used, and the like.

The document generation unit 104A inputs the generated prompt P1 to the language model M1, whereby the second document D2 is output from the language model M1. As described above, the document generation unit 104A can generate the second document D2 using the language model M1. The language model M1 may be included in the information processing apparatus 1A, or the language model M1 included in another apparatus such as a server may be used. In the latter case, the document generation unit 104A only needs to transmit the generated prompt P1 to another apparatus and acquire the second document D2 generated by using the language model M1, from the another apparatus. It is not essential to apply RAG. For example, the document generation unit 104A can generate the second document by inputting the first document to the language model M1.

### Example of Conversion

As described above, the description conversion unit 105A converts a description as a conversion target into a description that is different in expression from this description and is related in content to this description. Hereinafter, a conversion method of a description by the description conversion unit 105A will be described with reference to FIG. 5. FIG. 5 is a diagram for describing the conversion method of a description. More specifically, FIG. 5 illustrates a conversion method using a language model M2 obtained by performing machine learning on a natural language, and illustrates an example of conversion information 112A for converting a target description. The language model M2 may be the same model as the language model M1 used to generate the second document. For example, one language model may be used for both generation of the second document and conversion of the description. Similarly to the language model M1, the language model M2 may be included in the information processing apparatus 1A or may be included in another apparatus such as a server.

In a case where the conversion method using the language model M2 is applied, the information processing apparatus 1A (more specifically, the description conversion unit 105A) generates a prompt that includes a description as a conversion target and instructs to convert the description. For example, the description conversion unit 105A may generate a prompt that designates what type of conversion is to be performed, such as the prompt P2 illustrated in FIG. 5. Specifically, the prompt P2 instructs to abstract a description (hereinafter, referred to as an abstraction instruction prompt). By using the abstraction instruction prompt such as the prompt P2, it is possible to output, to the language model M2, a description in which an abstraction level of an expression is higher than that of the description before the conversion although the content is related to the description before the conversion. The abstraction level means a degree of abstraction.

For example, in the example of FIG. 5, the language model M2 outputs a description of “perform search” in response to an input of a prompt P2 including a description of “perform vector search by performing vector conversion on an input search word”. The description of “perform vector search by performing vector conversion on an input search word” indicates a specific method for search, whereas the description of “perform search” does not indicate a specific method and is an abstract description.

It is sufficient that the conversion to be instructed in the prompt input to the language model M2 is determined based on a relationship between a document including the description as a conversion target, and a document generated from this document or a document as a source of this document. For example, in a case where the description as the conversion target is included in the second document and the second document has a lower abstraction level than the first document, the description conversion unit 105A only needs to generate an abstraction instruction prompt such as the prompt P2. For example, in a case where the first document is the basic design document and the second document is the detailed design document as in the example of FIG. 4, such a prompt is suitable. The prompt P2 can also be generated by using a template similarly to the prompt P1.

On the other hand, in the above-described case where the second document has a lower abstraction level than the first document, if the description as the conversion target is included in the first document, the description conversion unit 105A only needs to generate a prompt (hereinafter, referred to as a concretization instruction prompt) for instructing to output a description with a lower abstraction level (in other words, concretized).

For example, the description conversion unit 105A may generate a prompt for instructing to convert a description as a conversion target to possess an abstraction level equivalent to that of a document generated from a document including this description or a document as a source of this document. In this case, the description conversion unit 105A may input, to the language model M2, the description as the conversion target together with the document generated from the document including this description or the document as the source of this document. As a result, it is possible to perform appropriate conversion according to the document. The document input to the language model M2 may be the entire text or a part of the document.

As described above, the information processing apparatus 1A includes the description conversion unit 105A that causes the language model M2 obtained by performing machine learning on a natural language to convert at least any of the description of the first document and the description of the second document by using a prompt. The prompt used by the description conversion unit 105A is an abstraction instruction prompt for instructing to abstract the input description or a concretization instruction prompt for instructing to concretize the input description. Therefore, according to the information processing apparatus 1A, in addition to the effect exhibited by the information processing apparatus 1, it is possible to obtain an effect that any description can be converted into a description possessing a different abstraction level.

The description conversion unit 105A can also convert a description by using the conversion information 112A as illustrated in FIG. 5. In the conversion information 112A illustrated in FIG. 5, descriptions that possess different expressions and related contents are associated with each other, and more specifically, descriptions that possess different abstraction levels and related contents are associated with each other.

For example, in the conversion information 112A illustrated in FIG. 5, descriptions of “vector search”, “semantic search”, and “hybrid search” are associated with a description of “search” that expresses “vector search”, “semantic search”, and “hybrid search” in a more abstract manner. The description conversion unit 105A can appropriately abstract a description of a document with a relatively lower abstraction level between the first document and the second document, by using such conversion information 112A. Conversely, the description conversion unit 105A can also appropriately concretize the description of a document with a relatively higher abstraction level.

The conversion information 112A may be generated for a specific first document or a specific second document, or may be applicable general-purpose information (for example, a synonym dictionary) without being limited to a specific document. For example, in the former case, conversion information 112A for conversion of each description included in the first document and conversion information 112A for conversion of each description included in the second document may be stored in the storage unit 11A or the like. The conversion information 112A may be stored in, for example, a database or the like used for RAG.

The conversion information 112A according to the types of the first document and the second document may be used. For example, in a case where the first document and the second document are software-related documents, conversion information 112A covering various terms related to software may be used. On the other hand, in a case where the first document and the second document are medical-related documents, conversion information 112A covering various medical terms may be used.

As described above, the description conversion unit 105A may perform conversion of changing (specifically, increasing or decreasing) the abstraction level of a target description. Such conversion is effective in a case where the abstraction level of the description is different between the first document and the second document. That is, as long as the target description is a document with a higher abstraction level between the first document and the second document, the description conversion unit 105A only needs to convert the description into a description with a lower abstraction level. On the other hand, as long as the target description is a document with a lower abstraction level between the first document and the second document, the description conversion unit 105A only needs to convert the description into a description with a higher abstraction level. As a result, it is possible to detect an appropriate related description.

Here, in general, since a specific description has more variations in expression, the accuracy of processing of concretizing a description by using the language model tends to be low. Therefore, the description conversion unit 105A may perform conversion by using conversion information 112A in which descriptions that possess different abstraction levels and related contents are associated with each other, in a case where the description is concretized, and may cause the language model M2 to perform conversion by using an abstraction instruction prompt, in a case where the description is abstracted. As a result, in addition to the effects exhibited by the information processing apparatus 1, it is possible to obtain an effect that both conversion of abstracting a description and conversion of concretizing a description can be performed with high accuracy.

The description conversion unit 105A may cause the language model M2 to perform conversion with reference to the conversion information 112A. As a result, it is possible to appropriately convert a description by applying the criteria of conversion indicated in the conversion information 112A. In this case, for example, the description conversion unit 105A only needs to generate a prompt that includes the conversion information 112A and instructs to abstract or concretize a description in consideration of a conversion pattern indicated in the conversion information 112A.

### Detection Method for Related Description

As described above, the detection unit 102A detects a related description related to a second description that is different in expression from a first description and is related in content to the first description from among descriptions included in a non-designated document that is not a target of designation of the first description among the first document and the second document. Hereinafter, a detection method for a related description by the detection unit 102A will be described. The second description is a description obtained by conversion by the description conversion unit 105A.

For example, the detection unit 102A may detect a related description from among a plurality of descriptions included in a non-designated document based on the similarity in content between each of the plurality of descriptions included in the non-designated document and the second description. As a result, in addition to the effects exhibited by the information processing apparatus 1, it is possible to obtain an effect that an appropriate related description can be detected.

A calculation method for a similarity is not particularly limited. For example, the detection unit 102A may generate a feature vector of the second description. The detection unit 102A may calculate a cosine similarity between the feature vector of the second description and the feature vector of each description included in the non-designated document. As described above, the feature vector can be generated by using Bi-Encoder or the like. As described above, RAG may be applied to generate the second document, and in a case where the RAG is applied, the feature vector of each description included in the first document is generated to generate the second document. Therefore, the detection unit 102A may calculate the cosine similarity by using the feature vector of each description included in the first document generated at the time of generating the second document.

The detection unit 102A detects a related description based on the similarity in the content between each of the plurality of descriptions included in the non-designated document and the second description, which has been calculated in a manner described above. For example, the detection unit 102A may detect a predetermined number of descriptions with a higher similarity to the second description among a plurality of descriptions included in the non-designated document, as related descriptions. For example, the detection unit 102A may detect a description whose similarity to the second description is equal to or more than a predetermined threshold value among a plurality of descriptions included in the non-designated document as a related description. In any case, the detection unit 102A may detect a plurality of descriptions as related descriptions.

Here, in a case where a configuration in which a description whose similarity to the second description is equal to or more than a predetermined threshold value is detected as a related description is adopted, the detection unit 102A may not be able to detect the related description. For example, in a case where a description related to the second description is firstly not included in the non-designated document, there is no description whose similarity to the second description is equal to or more than the predetermined threshold value. As a result, it is not possible for the detection unit 102A to detect the related description.

The second description to which a related description is not detected may be associated with a description that is not reflected during generation of the second document from the first document or a description that is erroneously written during generation of the second document from the first document. Therefore, in a case where no related description has been detected for the second description, the display control unit 106A may notify the user of the first description associated with the second description for which no related description has been detected.

As described above, the detection unit 102A may detect a description whose similarity in content to the second description is equal to or more than a predetermined threshold value among a plurality of descriptions included in the non-designated document as a related description. In a case where the detection unit 102A has not been able to detect a related description from the non-designated document, the display control unit 106A may notify the user of the first description associated with the second description. A case where the related description has not been able to be detected means a case where the non-designated document has not included a description whose similarity in content to the second description is equal to or more than a predetermined threshold value. As a result, in addition to the effect exhibited by the information processing apparatus 1, it is possible to obtain an effect that it is possible to cause the user to confirm whether the first description is a description that has not been reflected or whether the first description is a description that has been erroneously written. As described above, the information processing apparatus 1A can also be used for the application of facilitating work of confirming whether the second document is appropriate in view of the content of the first document. Any mode of notification is applicable, and for example, the display control unit 106A may make the notification by displaying characters or images. In this case, the display control unit 106A functions as notification means. For example, notification means may be provided separately from the display control unit 106A, and the notification means may make the above notification. In this case, the notification may be made in a mode other than the display (for example, voice).

The above-described detection method for a related description is merely an example. For example, the detection unit 102A can also detect a related description by using a language model obtained by performing machine learning on a natural language. In this case, the detection unit 102A only needs to input the second description and the non-designated document to the language model, and cause the language model to infer which description is related to the second description among the descriptions of the non-designated document. The detection unit 102A can also detect a related description by performing processing of inputting the second description and a description of a part of the non-designated document to the language model and causing the language model to infer whether these descriptions are related to each description included in the non-designated document.

### Generation of Correspondence Information

The detection of the related description described above may be executed in response to designation of the first description, or may be executed in advance before the designation of the first description is received. In the latter case, the detection unit 102A generates correspondence information 111A by using the detected related description and stores the correspondence information in the storage unit 11A or the like. As a result, at time of receiving the designation of the first description, the detection unit 102A can quickly detect the related description by referring to the correspondence information 111A.

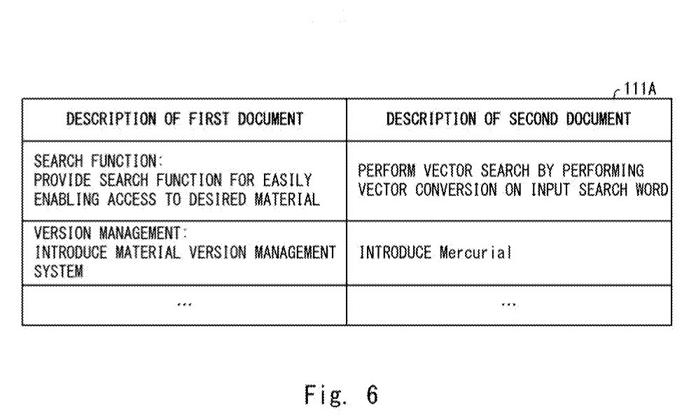

FIG. 6 is a diagram illustrating an example of the correspondence information 111A. Correspondence information 111A illustrated in FIG. 6 is information in which a description extracted from the first document and a description extracted from the second document are associated with each other, and the associated descriptions possess different expressions and related contents. For example, in the correspondence information 111A illustrated in FIG. 6, a description of “search function: provide a search function for easily enabling access to a desired material” in the first document and a description of “perform vector search by performing vector conversion on an input search word” in the second document are associated with each other. All of these descriptions are common and related in that the descriptions relate to searching. On the other hand, the former is different from the latter in that the former is an abstract description indicating an outline of the search function, and the latter is a specific description related to implementation of the search function.

For example, the detection unit 102A may detect a related description for each of a plurality of descriptions included in the first document, and generate the correspondence information 111A by associating the detected related description with the related description in the second document. Conversely, the detection unit 102A may detect a related description for each of a plurality of descriptions included in the second document, and generate the correspondence information 111A by associating the detected related description with the related description in the first document. According to these configurations, in addition to the effects exhibited by the information processing apparatus 1, it is possible to obtain an effect that the correspondence information 111A that enables quick detection of a related description at time of designating the first description can be automatically generated.

For example, in a case where a related description regarding a description of “perform vector search by performing vector conversion on an input search word” is detected in the correspondence information 111A illustrated in FIG. 6, the description conversion unit 105A first converts this description. In the example of FIG. 6, the first document is the basic design document, and the second document is the detailed design document with a lower abstraction level (in other words, the content is specific) than the basic design document. Therefore, the description conversion unit 105A converts the description of “perform vector search by performing vector conversion on the input search word”, which is the description of the second document, into a description with a higher abstraction level than this description. For example, as described with reference to FIG. 5, the description conversion unit 105A may generate an abstraction instruction prompt, input the generated abstraction instruction prompt to the language model M2, and convert the description. For example, the description conversion unit 105A may convert the description by using the conversion information 112A as illustrated in FIG. 5.

Then, the detection unit 102A detects, as a related description, a description with a content related to the description converted by the description conversion unit 105A among the descriptions included in the first document. For example, it is assumed that the description of “perform vector search by performing vector conversion on an input search word” is converted into the description of “perform search”. In this case, the detection unit 102A may generate a feature vector indicating the feature of the description of “perform search”. The detection unit 102A may calculate a cosine similarity between the generated feature vector and the feature vector of each description included in the first document, and detect a description in which the cosine similarity is equal to or more than a predetermined threshold, as the related description. The detection unit 102A can generate the conversion information 112A as illustrated in FIG. 5 by performing such processing on each description included in the second document.

### Display Screen Example

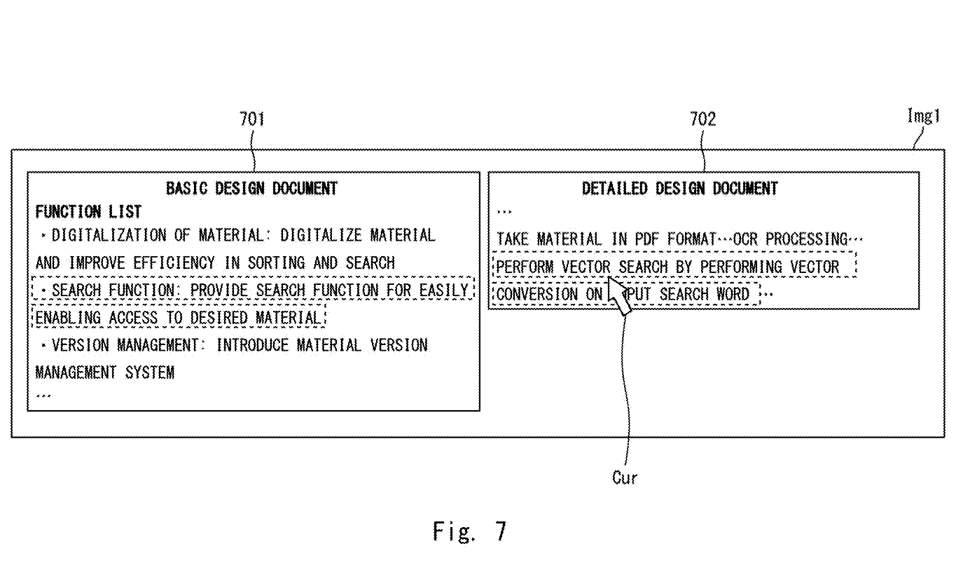

An example of a display screen displayed by the display control unit 106A will be described with reference to FIG. 7. FIG. 7 is a diagram illustrating the example of the display screen displayed by the display control unit 106A. A screen example Img1 illustrated in FIG. 7 includes a display area 701 for displaying a first document and a display area 702 for displaying a second document. A basic design document is displayed in the display area 701, and a detailed design document generated based on the basic design document is displayed in the display area 702.

Here, in the screen example Img1, a part of a description of the detailed design document displayed in the display area 702 is designated by a cursor Cur. The designated description is the first description described above. Thus, in the screen example Img1, the second document that is the detailed design document is the designated document, and the first document that is the basic design document is the non-designated document.

In the display area 702 of the screen example Img1, the designated first description is marked, and whereby the first description can be distinguished from other descriptions in the detailed design document. In the display area 701, the related description related to the first description is marked similarly to the first description, whereby the related description can be distinguished from other descriptions in the basic design document.

As described above, the display control unit 106A may display the non-designated document, and display the related description detected by the detection unit 102A among the displayed descriptions of the non-designated document in such a way as to be distinguishable from other descriptions. As a result, in addition to the effect exhibited by the information processing apparatus 1, it is possible to obtain an effect that the user can easily ascertain in what context the related description related to the first description designated by the user is described in the non-designated document. As described above, any display mode for making a certain description distinguishable from other descriptions is applicable. For example, in addition to a method of decorating a target description by marking or underlining, the target description can be made distinguishable from other descriptions by changing a display color and/or font of characters included in the target description.

### Flow of Processing

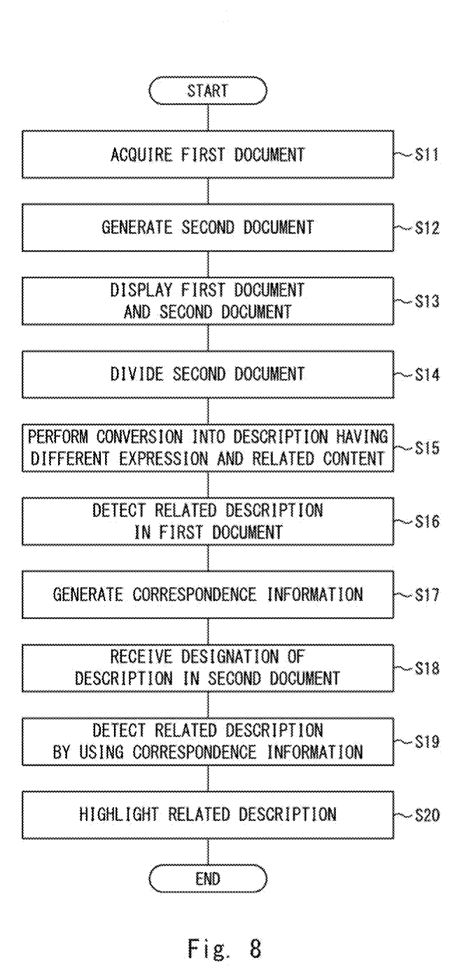

A flow of processing executed by the information processing apparatus 1A will be described with reference to FIG. 8. FIG. 8 is a flowchart illustrating a flow of processing executed by the information processing apparatus 1A. The flowchart of FIG. 8 includes each process of the detection method according to the present exemplary example embodiment.

In S11, the acquisition unit 103A acquires a first document as a source for generating a second document. Subsequently, in S12, the document generation unit 104A generates the second document from the first document acquired in S11. Further, in S13, the display control unit 106A displays the first document acquired in S11 and the second document generated in S12. For example, the display control unit 106A may display the first document and the second document side by side as in the screen example Img1 of FIG. 7. This makes it easier for the user to compare the first document with the second document.

In S14, the description conversion unit 105A divides the second document generated in S12 into groups of the content. For example, the description conversion unit 105A may divide the second document by a delimiter such as a period. In this case, the second document is divided in units of sentences. Any unit by which the second document is divided is applicable. For example, the description conversion unit 105A may divide the second document into a line feed part in the second document and/or a part in which a space is input in the second document, in accordance with the format of the second document.

In S15, the description conversion unit 105A converts a description of each section into a description that is different in expression from this description and is related in content to this description. As described above, the description conversion unit 105A may convert a description by using the conversion information 112A or may convert the description by using the language model M2. The description conversion unit 105A may use the conversion information 112A in a case where a description is abstracted, and may use the language model M2 in a case where a description is concretized. Whether to concretize or abstract the description in the conversion may be determined in advance in accordance with a relationship between a document including a description as a conversion target, and a document generated from this document or a document that is a source of this document. For example, in a case where the second document with more specific content than the first document is generated from the first document, the description conversion unit 105A only needs to abstract the description at time of converting the description of the second document.

In S16, the detection unit 102A detects the related description in the first document for each of a plurality of descriptions included in the second document (description of each section in S14). In the detection of the related description, for example, the detection unit 102A calculates a similarity between one of the converted descriptions in S15 and each of a plurality of descriptions included in the first document. The plurality of descriptions included in the first document are obtained by dividing the first document in units similar to those of the second document. For example, if the second document is divided in units of sentences, a similarity to each description obtained by dividing the first document in units of sentences is calculated. The detection unit 102A detects the related description based on the calculated similarity. The detection unit 102A can detect the related information of each description included in the second document by performing these processes for each of the plurality of descriptions obtained by the conversion in S15. As described above, there may be a case where it is not possible for the detection unit 102A to detect the related description. In this case, the display control unit 106A may make a notification that the related description has not been able to be detected together with the description to which the related description has not been able to be detected.

In S17, the detection unit 102A generates correspondence information 111A by associating the related description detected in S16 with a description related to the related description in the first document. The detection unit 102A stores the generated correspondence information 111A in the storage unit 11A or the like.

In S18 (reception process), the reception unit 101A receives an operation of designating a part (first description) of the description of the second document displayed in S13. That is, FIG. 8 illustrates an example in which the designated document is the second document and the non-designated document is the first document. The operation of designating the description is freely set, and for example, the description may be designated by using a cursor as in the example of FIG. 7.

In S19 (detection process), the detection unit 102A detects a related description related to a second description that is different in expression from a first description and is related in content to the first description from among descriptions included in a non-designated document that is not a target of designation of the first description among the first document and the second document. In the example of FIG. 8, since the non-designated document is the first document, the detection unit 102A detects the related description from the first document. Specifically, the detection unit 102A detects a description associated with the first description designated in S18 in the correspondence information 111A generated in S17, as the related description. As described above, the correspondence information 111A may be generated from the related description detected based on the similarity in S17. In the case of using the correspondence information 111A generated in this manner, it can be said that the detection unit 102A detects the related description from among the plurality of descriptions included in the non-designated document based on the similarity in the content between each of the plurality of descriptions included in the non-designated document and the second description in S19.

In S20, the display control unit 106A highlights the related description detected in S19 in the first document displayed in S13. The highlighting may be performed in a display mode in which a target description can be distinguished from other descriptions. In a case where the process of S20 ends, the processing of FIG. 8 ends.

The processes from S11 to S20 are not necessarily executed at a time, and the processes from S11 to S20 are not necessarily executed in the order of FIG. 8. That is, although the processes of S11 and S12 need to be executed first, the process of S13 may be executed at any timing until the process of S18 is executed. The processes of S14 to S17 may be executed at any timing until the process of S19 is executed.

The detection unit 102A may detect the related description without using the correspondence information 111A. In this case, after the reception unit 101A executes a reception process of receiving designation of a description (first description) in the second document, the description conversion unit 105A converts the first description. The detection unit 102A executes a detection process of detecting a related description by using the second description obtained by the conversion.

### Modified Examples

Any execution subject of each processing described in the above-described exemplary example embodiment and reference example is applicable, and is not limited to the above-described examples. For example, a system with functions similar to those of the information processing apparatuses 1 and 1A can be constructed by a plurality of apparatuses capable of communicating with each other. The execution subject of each process illustrated in the flowchart of FIG. 8 may be one apparatus (may be rephrased as a processor) or a plurality of apparatuses (may be similarly rephrased as processors).

### Example of Implementation by Software

Some or all of the functions of the information processing apparatuses 1 and 1A (hereinafter, also referred to as “each of the above apparatuses”) may be implemented by hardware such as an integrated circuit (IC chip) or may be implemented by software.

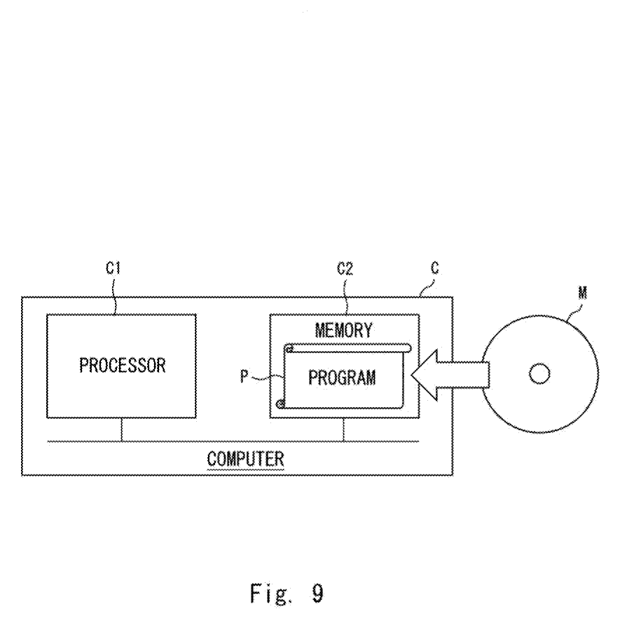

In the latter case, each of the above apparatuses is implemented by, for example, a computer that executes instructions of a program, that is software for implementing each function. FIG. 9 illustrates an example of such a computer (hereinafter, referred to as a computer C). FIG. 9 is a block diagram illustrating a hardware configuration of the computer C functioning as each of the above apparatuses.

The computer C includes at least one processor C1 and at least one memory C2. A program (detection program) P for operating the computer C as each of the above apparatuses is recorded in the memory C2. In the computer C, by the processor C1 reading the program P from the memory C2 and executing the program P, each function of each of the above apparatuses is achieved.

Available examples of the processor C1 include a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, and a combination thereof. Available examples of the memory C2 include a flash memory, a Hard Disk Drive (HDD), a Solid State Drive (SSD), and a combination thereof.

The computer C may further include a Random Access Memory (RAM) for expanding the program P at the time of execution and temporarily storing various types of data. The computer C may further include a communication interface for sending and receiving data to and from another apparatus. The computer C may further include an input/output interface for connecting input/output equipment such as a keyboard, a mouse, a display, and a printer.

Furthermore, the program P can be recorded on a non-transitory tangible recording medium M readable by the computer C.

Examples of the recording media M include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), cards, programable logic circuits and semiconductor memories (such as mask ROM, PROM (programmable ROM), EPROM (erasable PROM), flash ROM, RAM (random access memory), etc.). The computer C can obtain the program P with the recording media M. In addition, the program P may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line. The computer C can obtain the program P with the transitory computer readable media.

Each of the above functions of each of the above apparatuses may be achieved by a single processor provided in a single computer, may be achieved in cooperation with a plurality of processors provided in a single computer, or may be achieved in cooperation with a plurality of processors provided in each of a plurality of computers. The program for causing each of the above apparatuses to achieve each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Information

The present disclosure includes the technologies described in the following Supplementary Notes. However, the present disclosure is not limited to the techniques described in the following supplementary notes, and various modifications can be made within the scope described in the claims.

### Supplementary Note A1

An information processing apparatus including reception means for receiving an operation of designating a first description that is a part of a description of a first document or a second document generated by using the first document, on any of the first document and the second document, and detection means for detecting a related description that is related to a second description that is different in expression from the first description and is related in content to the first description from among descriptions included in a non-designated document that is not a target of designation of the first description among the first document and the second document.

### Supplementary Note A2

The information processing apparatus according to Supplementary Note A1, further including display control means for displaying the non-designated document and displaying the related description detected by the detection means among displayed descriptions of the non-designated document in such a way as to be distinguishable from other descriptions.

### Supplementary Note A3

The information processing apparatus according to Supplementary Note A1 or A2, in which the detection means detects the related description from among a plurality of descriptions included in the non-designated document based on a similarity in content between each of the plurality of descriptions included in the non-designated document and the second description.

### Supplementary Note A4

The information processing apparatus according to Supplementary Note A3, in which the detection means detects, as the related description, a description whose similarity in content to the second description is equal to or more than a predetermined threshold value among the plurality of descriptions included in the non-designated document, and the information processing apparatus further includes notification means for making a notification of the first description associated with the second description in a case where the non-designated document does not include the description whose similarity in content to the second description is equal to or more than the predetermined threshold value.

### Supplementary Note A5

The information processing apparatus according to any of Supplementary Notes A1 to A4, in which the detection means detects a related description for each of a plurality of descriptions included in the first document, and generates correspondence information by associating the detected related description with a description related in the second document, or detects a related description for each of a plurality of descriptions included in the second document, and generates correspondence information by associating the detected related description with a description related in the first document.

### Supplementary Note A6

The information processing apparatus according to any one of Supplementary Notes A1 to A5, further including description conversion means for causing a language model obtained by performing machine learning on a natural language to convert at least one of a description of the first document and a description of the second document by using an abstraction instruction prompt instructing to abstract an input description or a concretization instruction prompt instructing to concretize an input description.

### Supplementary Note A7

The information processing apparatus according to Supplementary Note A6, in which the description conversion means performs conversion by using conversion information in which descriptions with a different abstraction level and a related content are associated with each other, in a case where a description is concretized, and causes the language model to perform conversion by using the abstraction instruction prompt in a case where a description is abstracted.

### Supplementary Note B1

A detection method for causing at least one processor to execute a reception process of receiving an operation of designating a first description that is a part of a description of a first document or a second document generated by using the first document, on any of the first document and the second document, and a detection process of detecting a related description that is related to a second description that is different in expression from the first description and is related in content to the first description from among descriptions included in a non-designated document that is not a target of designation of the first description among the first document and the second document.

### Supplementary Note B2

The detection method according to Supplementary Note B1, further including a display control process of causing at least one processor to display the non-designated document and to display the related description detected by the detection process among displayed descriptions of the non-designated document in such a way as to be distinguishable from other descriptions.

### Supplementary Note B3

The detection method according to Supplementary Note B1 or B2, in which, in the detection process, the at least one processor detects the related description from among a plurality of descriptions included in the non-designated document based on a similarity in content between each of the plurality of descriptions included in the non-designated document and the second description.

### Supplementary Note B4

The detection method according to Supplementary Note B3, in which, in the detection process, the at least one processor detects, as the related description, a description whose similarity in content to the second description is equal to or more than a predetermined threshold value among the plurality of descriptions included in the non-designated document, and the at least one processor executes a notification process of making a notification of the first description associated with the second description in a case where the non-designated document does not include the description whose similarity in content to the second description is equal to or more than the predetermined threshold value.

### Supplementary Note B5

The detection method according to any of Supplementary Notes B1 to B4, in which the at least one processor detects a related description for each of a plurality of descriptions included in the first document, and generates correspondence information by associating the detected related description with a description related in the second document, or detects a related description for each of a plurality of descriptions included in the second document, and generates correspondence information by associating the detected related description with a description related in the first document.

### Supplementary Note B6

The detection method according to any one of Supplementary Notes B1 to B5, in which the at least one processor includes a description conversion process of causing a language model obtained by performing machine learning on a natural language to convert at least one of a description of the first document and a description of the second document by using an abstraction instruction prompt instructing to abstract an input description or a concretization instruction prompt instructing to concretize an input description.

### Supplementary Note B7

The detection method according to Supplementary Note B6, in which, in the description conversion process, the at least one processor performs conversion by using conversion information in which descriptions with a different abstraction level and a related content are associated with each other, in a case where a description is concretized, and causes the language model to perform conversion by using the abstraction instruction prompt in a case where a description is abstracted.

### Supplementary Note C1

A detection program for causing a computer to function as reception means for receiving an operation of designating a first description that is a part of a description of a first document or a second document generated by using the first document, on any of the first document and the second document, and detection means for detecting a related description that is related to a second description that is different in expression from the first description and is related in content to the first description from among descriptions included in a non-designated document that is not a target of designation of the first description among the first document and the second document.

### Supplementary Note C2

The detection program according to Supplementary Note C1, in which the computer is caused to function as display control means for displaying the non-designated document and displaying the related description detected by the detection means among displayed descriptions of the non-designated document in such a way as to be distinguishable from other descriptions.

### Supplementary Note C3

The detection program according to Supplementary Note C1 or C2, in which the detection means detects the related description from among a plurality of descriptions included in the non-designated document based on a similarity in content between each of the plurality of descriptions included in the non-designated document and the second description.

### Supplementary Note C4

The detection program according to Supplementary Note C3, in which the detection means detects, as the related description, a description whose similarity in content to the second description is equal to or more than a predetermined threshold value among the plurality of descriptions included in the non-designated document, and the computer is caused to function as notification means for making a notification of the first description associated with the second description in a case where the non-designated document does not include the description whose similarity in content to the second description is equal to or more than the predetermined threshold value.

### Supplementary Note C5

The detection program according to any of Supplementary Notes C1 to C4, in which the detection means detects a related description for each of a plurality of descriptions included in the first document, and generates correspondence information by associating the detected related description with a description related in the second document, or detects a related description for each of a plurality of descriptions included in the second document, and generates correspondence information by associating the detected related description with a description related in the first document.

### Supplementary Note C6

The detection program according to any one of Supplementary Notes C1 to C5, in which the computer is caused to function as description conversion means for causing a language model obtained by performing machine learning on a natural language to convert at least one of a description of the first document and a description of the second document by using an abstraction instruction prompt instructing to abstract an input description or a concretization instruction prompt instructing to concretize an input description.

### Supplementary Note C7

The detection program according to Supplementary Note C6, in which the description conversion means performs conversion by using conversion information in which descriptions possessing a different abstraction level and a related content are associated with each other, in a case where a description is concretized, and causes the language model to perform conversion by using the abstraction instruction prompt in a case where a description is abstracted.

### Supplementary Note D1

An information processing apparatus including at least one processor, in which the at least one processor executes a reception process of receiving an operation of designating a first description that is a part of a description of a first document or a second document generated by using the first document, on any of the first document and the second document, and a detection process of detecting a related description that is related to a second description that is different in expression from the first description and is related in content to the first description from among descriptions included in a non-designated document that is not a target of designation of the first description among the first document and the second document.

The information processing apparatus may further include a memory. The memory may store a detection program for causing the at least one processor to execute each type of the processing.

### Supplementary Note D2

The information processing apparatus according to Supplementary Note D1, in which the at least one processor executes a display control process of displaying the non-designated document and displaying the related description detected in the detection process among displayed descriptions of the non-designated document in such a way as to be distinguishable from other descriptions.

### Supplementary Note D3

The information processing apparatus according to Supplementary Note D1 or D2, in which, in the detection process, the at least one processor detects the related description from among a plurality of descriptions included in the non-designated document based on a similarity in content between each of the plurality of descriptions included in the non-designated document and the second description.

### Supplementary Note D4

The information processing apparatus according to Supplementary Note D3, in which, in the detection process, the at least one processor detects, as the related description, a description whose similarity in content to the second description is equal to or more than a predetermined threshold value among the plurality of descriptions included in the non-designated document, and executes a notification process of making a notification of the first description associated with the second description in a case where the non-designated document does not include the description whose similarity in content to the second description is equal to or more than the predetermined threshold value.

### Supplementary Note D5

The information processing apparatus according to any of Supplementary Notes D1 to D4, in which, in the detection process, the at least one processor detects a related description for each of a plurality of descriptions included in the first document, and generates correspondence information by associating the detected related description with a description related in the second document, or detects a related description for each of a plurality of descriptions included in the second document, and generates correspondence information by associating the detected related description with a description related in the first document.

### Supplementary Note D6

The information processing apparatus according to any one of Supplementary Notes D1 to D5, in which the at least one processor executes a description conversion process of causing a language model obtained by performing machine learning on a natural language to convert at least one of a description of the first document and a description of the second document by using an abstraction instruction prompt instructing to abstract an input description or a concretization instruction prompt instructing to concretize an input description.

### Supplementary Note D7

The information processing apparatus according to Supplementary Note D6, in which, in the description conversion process, the at least one processor performs conversion by using conversion information in which descriptions possessing a different abstraction level and a related content are associated with each other, in a case where a description is concretized, and causes the language model to perform conversion by using the abstraction instruction prompt in a case where a description is abstracted.

### Supplementary Note E

A non-transitory recording medium storing a detection program for causing a computer to execute a reception process of receiving an operation of designating a first description that is a part of a description of a first document or a second document generated by using the first document, on any of the first document and the second document, and a detection process of detecting a related description that is related to a second description that is different in expression from the first description and is related in content to the first description from among descriptions included in a non-designated document that is not a target of designation of the first description among the first document and the second document.

What is claimed is:

1. An information processing apparatus comprising:
one or more memories for storing instructions; and
one or more processors for executing the instructions,
wherein the one or more processors execute the instructions to:
receive an operation of designating a first description that is a part of a description of a first document or a second document generated by using the first document, on any of the first document and the second document; and
detect a related description that is related to a second description that is different in expression from the first description and is related in content to the first description from among descriptions included in a non-designated document that is not a target of designation of the first description among the first document and the second document.

2. The information processing apparatus according to claim 1, wherein the one or more processors execute the instructions to: display the non-designated document and display the detected related description among descriptions of the displayed non-designated document in such a way to be distinguishable from other descriptions.

3. The information processing apparatus according to claim 1, wherein the one or more processors execute the instructions to: detect the related description from among a plurality of descriptions included in the non-designated document based on a similarity in content between each of the plurality of descriptions included in the non-designated document and the second description.

4. The information processing apparatus according to claim 3,
wherein the one or more processors execute the instructions to:
detect, as the related description, a description whose similarity in content to the second description is equal to or more than a predetermined threshold value among the plurality of descriptions included in the non-designated document; and
make a notification of the first description associated with the second description in a case where the non-designated document does not include the description whose similarity in content to the second description is equal to or more than the predetermined threshold value.

5. The information processing apparatus according to claim 1,
wherein the one or more processors execute the instructions to:
detect a related description for each of a plurality of descriptions included in the first document, and generate correspondence information by associating the detected related description with a description related in the second document, or
detect a related description for each of a plurality of descriptions included in the second document, and generate correspondence information by associating the detected related description with a description related in the first document.

6. The information processing apparatus according to claim 1, wherein the one or more processors execute the instructions to: cause a language model obtained by performing machine learning on a natural language to convert at least one of a description of the first document and a description of the second document by using an abstraction instruction prompt instructing to abstract an input description or a concretization instruction prompt instructing to concretize an input description.

7. The information processing apparatus according to claim 6, wherein the one or more processors execute the instructions to: perform conversion by using conversion information in which descriptions possessing a different abstraction level and a related content are associated with each other, in a case where a description is concretized, and cause the language model to perform conversion by using the abstraction instruction prompt in a case where a description is abstracted.

8. A detection method for causing at least one processor to execute:
a reception process of receiving an operation of designating a first description that is a part of a description of a first document or a second document generated by using the first document, on any of the first document and the second document; and
a detection process of detecting a related description that is related to a second description that is different in expression from the first description and is related in content to the first description from among descriptions included in a non-designated document that is not a target of designation of the first description among the first document and the second document.

9. A non-transitory computer-readable medium storing a program for causing a computer to execute:
receiving an operation of designating a first description that is a part of a description of a first document or a second document generated by using the first document, on any of the first document and the second document; and
detecting a related description that is related to a second description that is different in expression from the first description and is related in content to the first description from among descriptions included in a non-designated document that is not a target of designation of the first description among the first document and the second document.
